(19) United States
(12) Patent Application Publication
(10) Pub. No.: US 2005/0117448 A1
(43) Pub. Date: Jun. 2, 2005

(54) Apparatus for mixing materials in containers

(75) Inventor: Antonio Bonita, Capannori (LUCCA) (IT)

Correspondence Address: ARENT FOX KINTNER PLOTKIN & KAHN, 1050 CONNECTICUT AVENUE, N.W., SUITE 400, WASHINGTON, DC, 20036, US

(73) Assignee: VIMA IMPIANTI S.r.I.

(21) Appl. No.: 10/991,368

(22) Filed: Nov. 19, 2004

(30) Foreign Application Priority Data
Nov. 28, 2003 (IT) BO2003A000725

(51) Int. Cl. B01F 11/00

(52) U.S. Cl. 366/209; 366/218

(57) ABSTRACT

The apparatus for mixing materials held in containers comprises a supporting structure, a mobile body, rotatably connected to the supporting structure in such a way that it rotates relative to the structure about a respective axis of rotation, motor means for driving said rotation and elements for fixing the container to the mobile body.

### BACKGROUND OF THE INVENTION

The present invention relates to an apparatus for mixing materials held in respective containers.

In particular, the present invention relates to an apparatus which can be used in the chemical and/or pharmaceutical and/or food sector and in any other sector requiring the mixing of loose material consisting of powders, pellets, tablets, capsules or similar products held in respective containers.

To mix the substances of which said material is composed so that, at the end of this operation, the material has the required level of homogenization, the above-mentioned containers are moved.

Mixing apparatuses are known which comprise a fixed structure and a mobile body to which the container is fixed and motor means designed to move the mobile body, rotating the mobile body, and the container fixed to it, about a respective axis of rotation.

This rotation of the container mixes the loose material contained inside it.

The above-mentioned containers are normally made with an axially symmetrical shape and are mounted on a respective supporting frame usually having a quadrangular base and four faces.

To increase the efficiency of the mixing, so-called single angle apparatuses were developed, in which once the container frame is fixed to the mobile body, the face of the frame in contact with the mobile body is set at an angle to the latter's axis of rotation.

To further increase the efficiency of the mixing effect, both to reduce the time it requires and to allow the use of increasingly large containers, so-called double angle apparatuses were made, in which the axis of rotation of the mobile body is at an angle to the horizontal plane.

The latter type of apparatus was extremely efficient but still not without disadvantages.

In particular, the fact that the mobile body axis of rotation is at an angle means that the apparatus has to be equipped with complex devices for loading/unloading containers whose faces are perpendicular to the ground.

Said devices must therefore angle the mobile body to bring its axis of rotation parallel with the ground and then return it to the angled configuration after the container has been fixed to it or, alternatively, angle the container to bring one of its faces perpendicular to the mobile body axis of rotation and fix it that way.

Obviously, given the large dimensions of the apparatuses and containers and the significant weights involved, each of the operations described above is particularly complex and difficult and expensive to implement.

### SUMMARY OF THE INVENTION

The aim of the present invention is to provide an apparatus for mixing loose materials which overcomes the above-mentioned disadvantages and which is, at the same time, functional, simple and economical to produce and practical and effective to use.

The technical features of the present invention, in accordance with the above-mentioned aim, are set out in the claims herein, in particular claim 1 and, preferably, any of the claims directly or indirectly dependent on claim 1.

### BRIEF DESCRIPTION OF THE DRAWINGS

The advantages of the present invention are more clearly described in the detailed description below, with reference to the accompanying drawings, which illustrate a preferred embodiment of the invention, without limiting the scope of its application, and in which:

FIG. 1 is a top perspective view of a preferred embodiment of an apparatus for mixing loose materials made according to the present invention;

FIGS. 2, 3 and 4 are respective schematic side elevation views of the apparatus illustrated in FIG. 1 in three different operating configurations;

FIG. 5 is a top plan view of the apparatus illustrated in the previous figures.

### DESCRIPTION OF THE PREFERRED EMBODIMENTS

With reference to the accompanying drawings, the numeral 1 denotes as a whole a first embodiment of an apparatus for mixing loose materials held in containers 2.

The containers 2 are of the known type and are normally used to hold loose materials in the pharmaceutical and/or chemical and/or food sector.

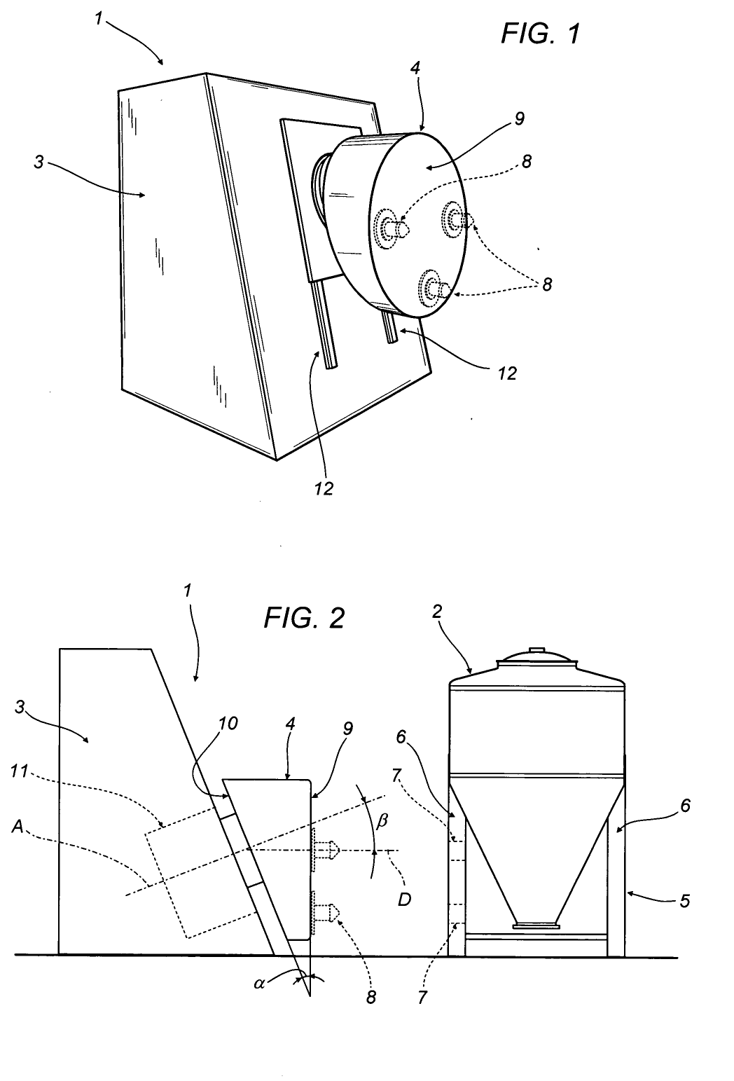

As illustrated in FIG. 1, the apparatus 1 comprises a fixed supporting structure 3 and a mobile body 4 which is rotatably connected to the fixed structure 3.

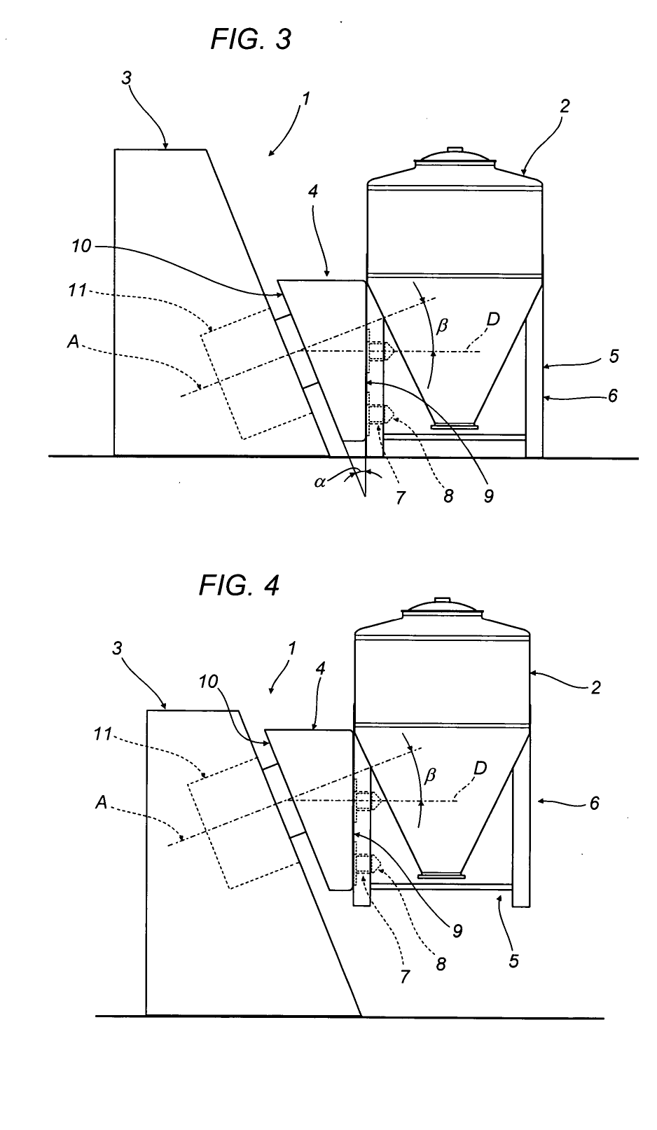

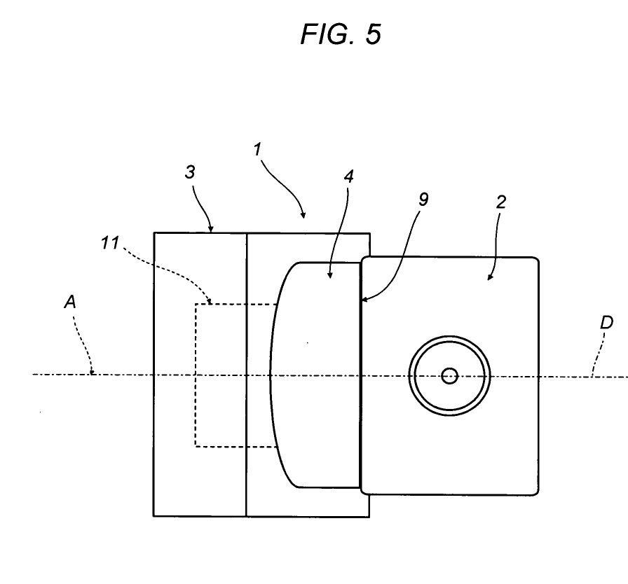

The container 2, illustrated in a side elevation view in FIGS. 2, 3, 4 and a plan view in FIG. 5, is mounted on a respective supporting frame 5 with a quadrangular base which comprises vertical uprights 6 forming respective side faces, their lower ends normally fitted with wheels, not illustrated, designed for container transportation.

As illustrated in FIG. 2, at one of said faces, perpendicular to the illustration plane, the frame 5 comprises engagement portions 7, schematically illustrated with dashed lines, designed to receive respective fixing elements 8 located on the mobile body 4 and described in further detail below.

In particular, in the embodiment illustrated in the accompanying drawings, the mobile body 4 has a first, front face 9 and a second, rear face 10 which is opposite the fixed structure 3.

The two faces, front and rear 9, 10 are set at an angle α to one another.

The apparatus 1 comprises first motor means, of the substantially known type and schematically illustrated in the accompanying drawings with a dashed block 11, designed to cause the mobile body 4 to rotate relative to the fixed structure 3, about a respective axis of rotation A.

The axis of rotation A is set at an angle β to a horizontal direction D parallel with the ground.

Advantageously, according to the preferred embodiment illustrated in the accompanying drawings, the angles α and β are equal to one another and measure approximately 15°.

As illustrated in FIG. 1, on the first, front face 9 of the mobile body 4 there are three fixing elements 8 designed to engage, in ways not described in this text, with the above-mentioned frame 5 engagement portions 7 to fix the container 2 to the mobile body 4.

With reference to FIG. 1, the mobile body 4, driven by respective second motor means, not illustrated, is designed to move, on guides 12, between a first, lowered position, illustrated in FIG. 3, in which it assumes a container 2 loading configuration, and a second, raised operating position, illustrated in FIG. 4, in which it is designed to be rotated about its axis A to mix the loose materials held in the container 2.

The guides 12 form a movement plane, not labeled, advantageously perpendicular to the axis of rotation A of the mobile body 4.

As illustrated in FIG. 1, in the container 2 loading configuration, the first face 9 of the mobile body 4 is perpendicular to the projection of the axis of rotation A in a horizontal plane which is, therefore, perpendicular to the illustration plane and whose line in the illustration plane is represented by the direction D.

In practice, as illustrated in FIG. 2, with the mobile body 4 in its first, lowered position in which its assumes its loading configuration, the container 2 is brought close to the apparatus 1 with the face of the frame 5 comprising the afore-mentioned engagement portions 7 opposite the first, front face 9 of the mobile body 4.

As illustrated in FIG. 3 and using methods not described in detail since they are not important in this text, the fixing elements 8 located on the mobile body 4 are secured to the respective engagement portions 7 of the frame 5 to lock the frame 5, and the container 2 which is integral with it, to the mobile body 4.

With reference to FIG. 4 and starting from the lowered position illustrated in FIG. 3, the mobile body 4 is raised by actuators, not illustrated, to assume said second, raised operating position in which it is designed to be rotated about its axis A to mix the loose materials held inside the container 2 fixed to the mobile body 4.

In this way, double angle mixing is achieved.

Said mobile body 4 first face 9 is, generally speaking, a plane formed by the fixing elements 8 and the respective frame 5 engagement portions 7 and perpendicular to a direction in which they are brought together.

In other words, for the purposes of this text, the first face 9 may be formed by a virtual plane and not necessarily an actual surface.

Substantially as just described with reference to the first face 9, the mobile body 4 second face 10 is, generally speaking, any plane perpendicular to the axis of rotation A of the mobile body 4.

In other words, for the purposes of this text, the second face 10 may also be formed by a virtual plane and not necessarily an actual surface.

Advantageously, the present invention can provide a mixing apparatus with double angling of the container but which does not require complex devices and/or procedures for loading the containers 2. Indeed, according to the present invention, the container 2 can be loaded on the mobile body 4 without having to change the angle of its axis of rotation A or having to angle the container 2 itself and, on the contrary, the container 2 is brought close to the mobile body 4 in a direction lying in the plane formed by the axis of rotation A and by the plane perpendicular to the front face 9 passing through the axis A.

Advantageously, the apparatus 1 disclosed and in particular the mobile body 4 are at least partly made of stainless steel.

The invention described is suitable for evident industrial applications and may be subject to modifications and variations without thereby departing from the scope of the inventive concept. Moreover, all details of the invention may be substituted by technically equivalent elements.

1) an apparatus for mixing materials held in containers, comprising:
a supporting structure,
a mobile body, rotatably connected to the supporting structure so as to rotate relative to the supporting structure about a respective axis of rotation,
first motor means for driving the rotation of the mobile body,
means for fixing the container to the mobile body, the fixing means being located on the mobile body and the mobile body having a first face designed to be opposite the container and a second face opposite the supporting structure,
the axis of rotation being set at an angle to a horizontal direction,
the first and second faces of the mobile body being set at an angle to one another, and the second face being substantially perpendicular to the axis of rotation, wherein the mobile body is designed to assume a container loading configuration in which the first face of the mobile body is perpendicular to the projection of the axis of rotation in a horizontal plane.

2) The apparatus according to claim 1, wherein the mobile body is designed to move between a first, lowered position in which it assumes the container loading configuration and a second, raised operating position in which it is designed to be rotated to mix the loose materials held inside the container fixed to the mobile body.

3) The apparatus according to claim 2, wherein it comprises second motor means for driving the movement of the mobile body between its first and second positions.

4) The apparatus according to claim 2, wherein the body is designed to move in a plane perpendicular to its axis of rotation to pass between its first and second positions.

5) The apparatus according to any of the foregoing claims from 1 to 4, in which the axis of rotation is set at a first angle to a horizontal direction and the first and second faces are set at a second angle to one another, wherein the first and second angles are substantially equal.

6) The apparatus according to claim 5, wherein the substantially equal first and second angles measure between 10° and 20°.

7) The apparatus according to claim 6, wherein the first and second angles measure approximately 15°.

8) The apparatus according to claim 1, wherein the mobile body is at least partly made of stainless steel.
